(19) United States
(12) Patent Application Publication
(10) Pub. No.: US 2005/0102428 A1
(43) Pub. Date: May 12, 2005

(54) Memory management for ternary CAMs and the like

(76) Inventors: Nevin C. Heintze, Worthington, OH (US); Edward K. Walters II, Belchertown, MA (US)

Correspondence Address: MENDELSOHN AND ASSOCIATES PC, 1515 MARKET STREET, SUITE 715, PHILADELPHIA, PA, 19102, US

(21) Appl. No.: 10/948,483

(22) Filed: Sep. 23, 2004

Related U.S. Application Data
(60) Provisional application No. 60/519,293, filed on Nov. 12, 2003.

(51) Int. Cl. G06F 15/16; G06F 12/00

(52) U.S. Cl. 709/245; 711/108; 711/170

(57) ABSTRACT

To support IP routing table longest-prefix matching, a (ternary content-addressable) memory is managed by assigning its locations to interleaved pages and gaps. Each page has zero or more locations assigned to it, where all entries in a page have the same prefix length. Each gap has zero or more empty locations assigned to it. The pages are organized by descending prefix length. Associated with each page is a free-list identifying empty locations in that page. An “invariant” rule may dictate that first and last page locations cannot be empty. Whenever an entry is deleted from the first or last location in a page, that location is shifted (i.e., reassigned) to the adjacent gap. The direction chosen to search for an empty location for inserting a new entry is based on a global measure of the relative fullness of memory regions above and below the new entry's page.

### CROSS-REFERENCE TO RELATED APPLICATIONS

This application claims the benefit of the filing date of U.S. provisional application No. 60/519,293, filed on Nov. 12, 2003 as attorney docket no. Heintze 8-1.

### BACKGROUND OF THE INVENTION

1. Field of the Invention

The present invention relates to computer memory, and, in particular, to ternary content-addressable memory (T-CAM).

2. Description of the Related Art

One of the main components of packet processing in a network switch is packet classification. Packet classification involves inspection of the headers of a packet to determine the actions that should be taken to handle the packet. This includes identifying the packet's protocol, as well as inspecting packet destination information (e.g., destination IP addresses for IP (internet protocol) packets and destination labels for MPLS (multiple path label switched) packets). This process typically involves some form of matching.

In the case of MPLS, a forwarding table is maintained, whose entries consist of an incoming label, the corresponding outgoing label, the outgoing interface, and next hop address information. In this case, matching simply involves looking up the incoming label of the packet in this table.

For IP routing, the situation is more complex because it involves partial matching. Entries in an IP version 4 (IPv4) forwarding table consist of an IP address “pattern” (i.e., a.b.c.d/e, where a.b.c.d represents a 32-bit IP address and e represents the number of bits to be matched) and forwarding information for addresses that match that pattern. An example of the patterns that might appear in such a table is given in FIG. 1. An entry such as 125.42.34.8/32 specifies an exact match, where all 32 bits must match (i.e., a matching address must be exactly 125.42.34.8). In contrast, the entry 125.42.34.0/24 specifies a partial match, where a matching address need only agree on the first 24 bits of this pattern, so that, for example, 125.42.34.0, 125.42.34.1, and 125.42.34.42 would all be matches for the entry 125.42.34.0/24.

With partial matching, the possibility of multiple matches exists. For example, the IP address 125.42.34.8 would match the first, third, fifth, and sixth address patterns in FIG. 1 (counting from top to bottom). The convention is to pick the longest match. This is called longest-prefix matching.

One common way to implement longest-prefix matching is to use a specific kind of content-addressable memory (CAM) called ternary content-addressable memory (T-CAM). CAM differs from standard memory as follows: in standard memory, an “input address” is specified and the memory returns the data stored at that address; in CAM, “input data” is specified and the memory returns the address where that data is stored. Ternary CAMs enhance the functionality of standard (binary) CAMs with the addition of a “local mask” for each entry, where the local mask has the same number of bits as the CAM entries. This mask specifies which bits of an entry must coincide with the input data for there to be a match.

In T-CAMs, the issue of multiple matches is treated as follows: entries that appear earlier in memory (according to location address) are given priority. This means that, in order to implement longest-prefix matching in a T-CAM in an efficient manner (i.e., where each longest-prefix lookup requires only one T-CAM read operation), the entries should be in a specific order with longer matches appearing before shorter matches. For example, the entries in FIG. 1 are in an appropriate order for longest-prefix matching. Note that the first and second entries (and similarly the third and fourth entries) could be swapped without adversely affecting matching. However, swapping the second and third entries, for example, would adversely affect matching.

For a static IP forwarding table, it is a simple matter to sort the table according to prefix length and then insert the table entries into a T-CAM according to this order. However, forwarding tables are typically dynamic with entries continually being inserted and deleted on-the-fly. In principle, entries can be moved around to accommodate insertions.

For example, suppose the entry 125.42.34.9/32 is to be inserted into the eight-position table shown in FIG. 1 (where the last two locations are empty). One option would be to move all six existing entries down one space (where down represents motion towards the end of the table) and insert the new entry 125.42.34.9/32 at the top of the table. This would involve a total of six entry moves plus the insertion of the new entry.

Another option for this example would be to move the last four existing entries down one space and insert the new entry 125.42.34.9/32 into the newly empty third location between 125.42.34.6/32 and 125.42.34.0/24. Since 125.42.35.9/32 has the same prefix length as the entries 125.42.34.8/32 and 125.42.34.6/32 in the top two table locations, the resulting table after insertion of the new entry would still be appropriately organized for efficient longest-prefix searching, since entries with the same prefix length can be in any order relative to each other. This second option would involve a total of only four entry moves plus the new entry insertion.

To support high rates of insertions and deletions, it is critical to keep the number of moves to a minimum in order to minimize processing overhead. As the previous example suggests, the particular strategy used to insert new entries can significantly impact the number of moves.

### SUMMARY OF THE INVENTION

Problems in the prior art are addressed in accordance with the principles of the present invention by a (e.g., T-CAM) memory management scheme that organizes the T-CAM memory locations into pages and (preferably) gaps between pages. The pages are appropriately organized within the T-CAM to enable efficient longest-prefix matching (e.g., by descending prefix length). At any instant in time, each page has zero, one, or more memory locations associated with it, each of which may be either empty or contain an existing table entry, where all existing table entries in a page have the same prefix length. A gap is a set of zero, one, or more contiguous, empty memory locations. In one embodiment, there is a gap on each side of each page. Associated with each page is a list (called a free-list) of those (zero, one, or more) locations associated with that page that are currently empty (i.e., free).

According to the present invention, the free-lists and, if implemented, the gaps are used to determine where to insert new table entries into the T-CAM. In one embodiment, if possible, a new table entry is preferably inserted into an empty location in the corresponding page. If that page does not contain any empty locations, then the gaps immediately on either side of the page are checked to see if either has at least one empty location. If there are no empty locations in the gaps on either immediate side of the page, then a direction is chosen to search for the first page or gap having an empty location. In this case, one or more existing table entries might need to be moved (in the chosen direction) in order to free up the location at the corresponding edge of the page into which the new entry is then inserted. In addition to moving existing table entries, the T-CAM memory management scheme updates, as appropriate, each free-list and each set of locations associated with either a gap or a page. In general, a memory location can be shifted (i.e., reassigned) from a gap to an adjacent page, and vice versa.

In a preferred embodiment, the T-CAM memory management scheme calculates, for each page, a global measure of the relative fullness of the regions of the T-CAM above and below the page and uses these global measures to choose which directions to use to search for empty locations when inserting new entries into the T-CAM.

In one embodiment, the present invention is a method for managing storage of entries in a memory. The memory is organized into pages, each page having zero, one, or more memory locations adapted to store entries sharing a common attribute. A free-list is maintained for each page, wherein each free-list identifies any empty memory locations currently in the corresponding page, and storage of the entries in the memory is managed based on the free-lists.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows an exemplary eight-entry IP forwarding table having six IP address patterns and two empty locations;

FIG. 2 shows a block diagram of a memory system having a ternary content-addressable memory (T-CAM) and a memory manager, according to one embodiment of the present invention;

FIG. 3 shows a flow diagram of the processing implemented by the memory manager of FIG. 2 when a new table entry is to be inserted into the T-CAM of FIG. 2, according to one embodiment of the present invention;

FIG. 4 shows a portion of the T-CAM of FIG. 2 that illustrates an example of a situation in which there is at least one empty location in the gap immediately adjacent (in the chosen direction) to the page associated with a new table entry;

FIG. 5 shows a portion of the T-CAM of FIG. 2 that illustrates an example of a situation in which there are no empty locations in the gap immediately adjacent (in the chosen direction) to the page associated with a new table entry, but the subsequent page (in the chosen direction) has at least one empty location in its free-list;

FIG. 6 shows a portion of the T-CAM of FIG. 2 that illustrates an example of a situation in which one or more existing entries need to be moved in order to ensure that the location immediately adjacent to the page associated with a new table entry is empty;

FIG. 7 shows a portion of the T-CAM of FIG. 2 that illustrates an example of a situation in which no existing entries need to be moved in order to ensure that the location immediately adjacent to the page associated with a new table entry is empty;

FIGS. 8-10 show pseudocode for inserting a new table entry into a T-CAM, according to one embodiment of the present invention;

FIG. 11 shows a flow diagram of the processing implemented by the memory manager of FIG. 2 when an existing table entry needs to be deleted from the T-CAM of FIG. 2, according to one embodiment of the present invention;

FIG. 12 shows pseudocode for deleting an existing table entry from a T-CAM, according to one embodiment of the present invention;

FIG. 13 shows pseudocode for a pressure-based insertion algorithm, according to one embodiment of the present invention; and

FIG. 14 shows pseudocode for an insertion algorithm that distinguishes between low pressure and high pressure situations.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

Memory System

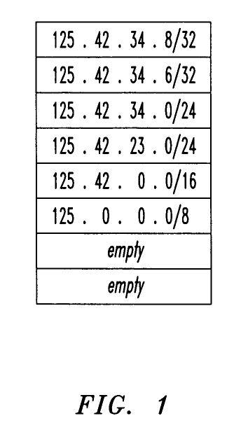

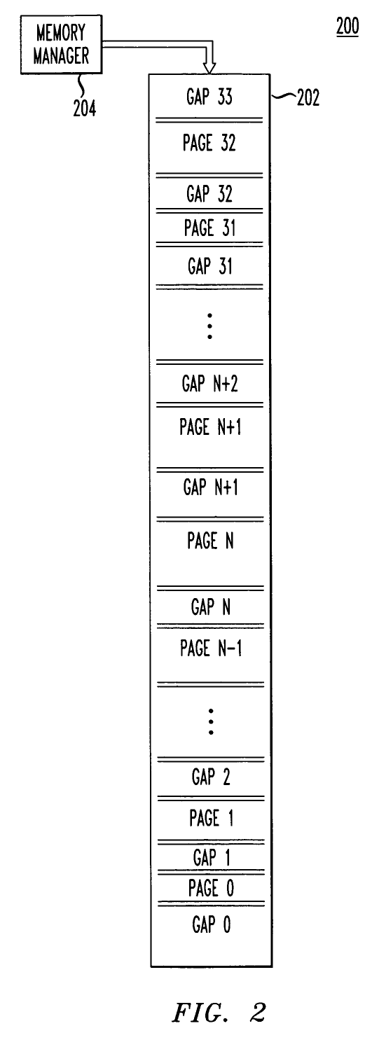

FIG. 2 represents a memory system 200 having a ternary content-addressable memory (T-CAM) 202 and a memory manager 204, according to one embodiment of the present invention. In one possible application, T-CAM 202 is used to store an IPv4 forwarding table in which each entry has a 32-bit IP address and a mask indicating the number of bits required for a match, as described previously in the context of FIG. 1. In this application, memory manager 204 manages the organization of the table entries stored in T-CAM 202 in order to support efficient longest-prefix matching. In particular, memory manager 204 is responsible for deleting existing table entries in T-CAM 202 that are no longer needed, as well as inserting new table entries into T-CAM 202 in such a way that ensures that table entries are always organized by descending prefix length.

As indicated in FIG. 2, according to one embodiment of the present invention, memory manager 204 organizes the available memory locations in T-CAM 202 into 33 different pages corresponding to all integer prefix lengths from 0 to 32. At any instant in time, each different page may independently have zero, one, or more memory locations associated with it, each of which may be either empty or contain an existing table entry, where all existing table entries in a page have the same prefix length. In addition, memory manager 204 defines a gap before and after each page, where, at any instant in time, each different gap may independently have zero, one, or more contiguous, empty memory locations associated with it. As indicated in FIG. 2, there are a total of 34 gaps interleaved with the 33 pages. Note that, in FIG. 2, the sizes of pages and gaps can vary from page to page and from gap to gap.

At any instant in time, in addition to storing one or more existing table entries, a page may have one or more memory locations that are empty (i.e., not currently used to store an existing table entry). Before the first table entry is inserted in to T-CAM 202, all of the memory locations are empty. In addition, a memory location will become empty when an existing entry is deleted from the table. Memory manager 204 maintains a different “free-list” for each different page, where each free-list identifies the zero, one, or more empty (i.e., free) memory locations currently in the associated page.

In principle, memory manager 204 is able to read and write any table entry from and to any memory location. For example, memory manager 204 is able to move any existing table entry from its current memory location to any other memory location. As described further below, this capability enables memory manager 204 to move an existing table entry from the top (or bottom) of a page to another, empty location in the page, thereby creating a situation in which the location at the top (or bottom) of the page is empty. Memory manager 204 is also able to shift (i.e., change the assignment of) an empty memory location from a gap to an adjacent page, and vice versa.

Inserting New Table Entries

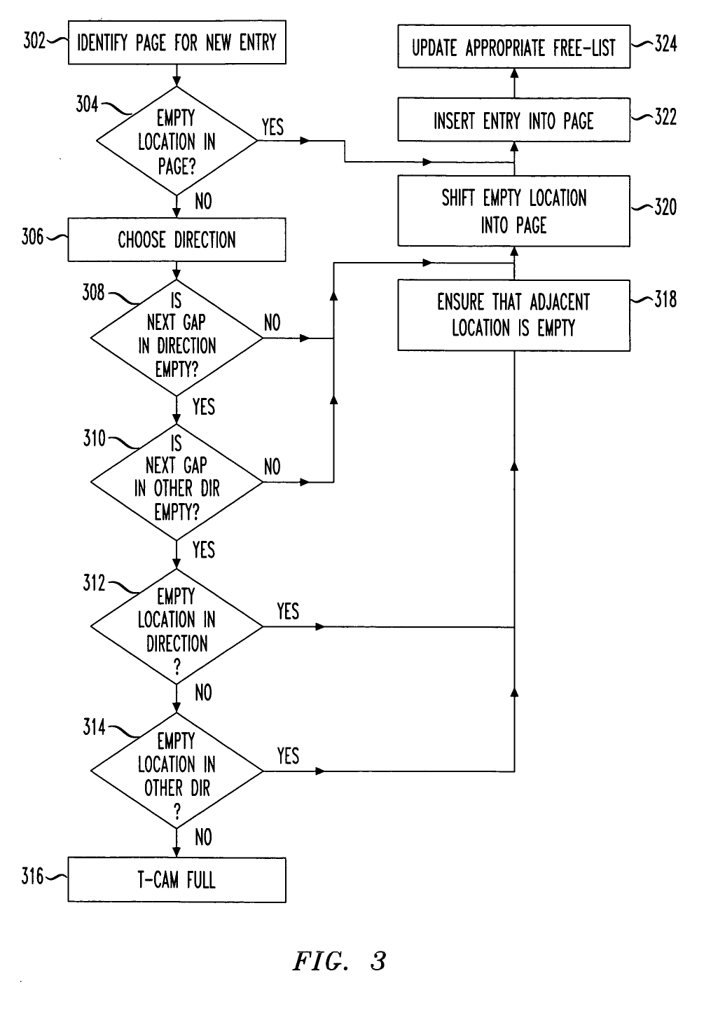

FIG. 3 shows a flow diagram of the processing implemented by memory manager 204 when a new table entry is to be inserted into T-CAM 202, according to one embodiment of the present invention.

According to this embodiment of the present invention, after the process of inserting or deleting each table entry is complete, pages are not allowed to start or end with an empty location. This rule is referred to herein as the invariant. The motivation for the invariant is the desire to maximize the sizes of gaps. To achieve this goal, any free location at the start or end of a page is shifted into the adjacent gap. This is beneficial because gap locations can be more flexibly managed than free-list locations, because they can ultimately be used by either the page preceding or succeeding the gap, whereas a free-list location can only be used by its associated page. Maximizing gaps assists in adapting the page structure as the profile of IP forwarding data changes (e.g., as the populations of different pages change).

Memory manager 204 begins by identifying the page in T-CAM 202 corresponding to the prefix length of the new table entry to be inserted (step 302 of FIG. 3). This page is referred to herein as the page “associated with” the new table entry.

Whenever possible, memory manager 204 prefers to insert a new table entry into an empty location in the page associated with the new entry, since, in this case, no existing table entries need to be moved to make room for the new entry. Memory manager 204 determines whether the associated page has an empty location by examining the free-list associated with that page. If the free-list indicates that the associated page has at least one empty location (step 304), then memory manager 204 inserts the new entry into one of those empty locations (step 322), where the particular empty location used may be chosen based on some specified rule (e.g., use first empty location in free-list). Note that the entries within each free-list will typically not be in any particular order. Since all of the entries in a page have the same prefix length, it does not matter which empty location is selected in order to achieve efficient longest-prefix matching. Another way of saying this is that the order of entries within each page is not constrained. After inserting the new entry into a previously empty location, memory manager 204 removes that location from the page's free-list (step 324).

If the associated page has no empty locations (i.e., the associated page is “full”), then memory manager 204 chooses a direction in which to search for an empty location outside of the associated page (step 306). There are a variety of different ways to choose a search direction. For example, the search direction could arbitrarily always be chosen to be “up” (or alternatively “down”). In other implementations, the search direction could be chosen randomly or the choice could alternate between “up” and “down” for successive new entry insertions. In a preferred implementation, the direction is chosen based on a global measure of the relative fullness of regions in the T-CAM above and below the associated page. One such measure (referred to herein as “pressure”) is described later in this specification. In any case, to insert each new entry, memory manager 204 chooses, in step 306, either the “up” direction or the “down” direction.

The different configurations of memory locations outside of an associated page that is currently full can be defined as belonging to one of two different categories. The first category includes those configurations in which at least one of (i) the gap immediately above the top of the associated page and (ii) the gap immediately below the bottom of the associated page has an empty location associated with it. The second category includes those configurations in which neither (i) the gap immediately above the top of the associated page nor (ii) the gap immediately below the bottom of the associated page has an empty location associated with it (i.e., both gaps are empty).

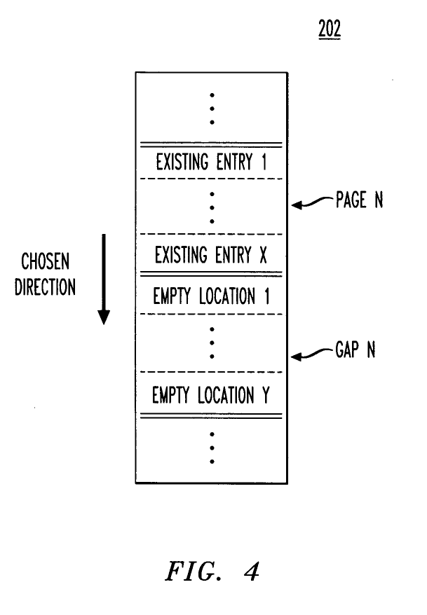

FIG. 4 shows a portion of T-CAM 202 of FIG. 2 that illustrates an example of the first category. In this example, page N is the page associated with the new table entry, and gap N is the first gap in the chosen direction (i.e., down, in this example). As indicated in FIG. 4, page N has XT-CAM memory locations associated with it, each of which already has an existing table entry, while gap N has Y (empty) T-CAM memory locations associated with it, where X and Y are both positive integers. In this case, a new table entry could be inserted into T-CAM 202 by performing the following operations:
Shift empty location 1 of gap N into the page N. This will increment by one the number of locations associated with page N and decrement by one the number of locations associated with gap N.
Insert the new table entry into the newly added (empty) location at the bottom of page N.
   In this way, the new table entry can be inserted into T-CAM 202 without moving any existing table entries.

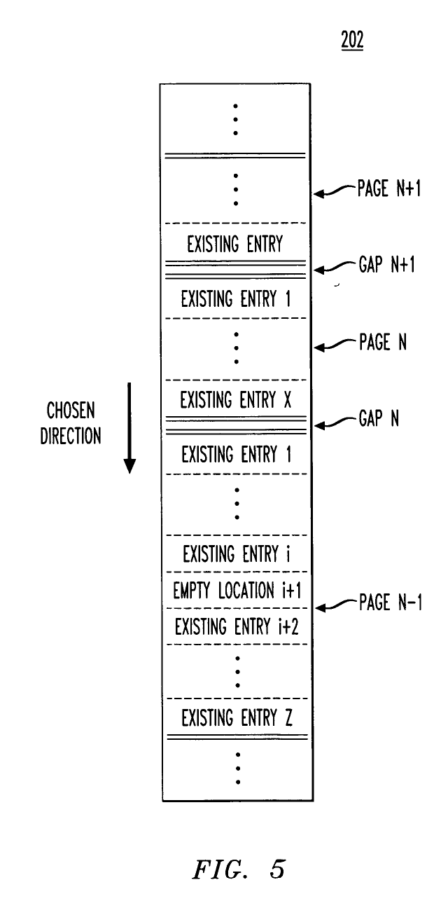

FIG. 5 shows a portion of T-CAM 202 that illustrates an example of the second category. In this example, page N is the page associated with the new table entry, gap N is the first gap in the chosen direction (i.e., down), page N−1 is the next page in the chosen direction, gap N+1 is the first gap in the other direction (i.e., up), and page N+1 is the next page in the other direction. As indicated in FIG. 5:
Page N has XT-CAM memory locations associated with it, each of which already has an existing table entry, where X is a positive integer;
Each of gaps N and N+1 has no (empty) T-CAM memory locations associated with it;
Page N−1 has Z T-CAM memory locations associated with it, where the upper i locations have existing table entries, location i+1 is empty, and the remaining (Z−(i+1)) locations have existing table entries, where Z and i are positive integers and (Z>i); and
The bottom location in page N+1 has an existing entry.
   In this case, a new table entry could be inserted into T-CAM 202 by performing the following operations:
Move the existing table entry from the top (i.e., location 1) of page N−1 into empty location i+1. This will free up (i.e., make empty) the location at the top of page N−1.
Shift the empty location at the top of page N−1 into the page N. This will increment by one the number of locations associated with page N and decrement by one the number of locations associated with page N−1, while keeping the number of locations associated with gap N at zero. (Depending on the implementation, this operation might be executed by first shifting the empty location from page N−1 into gap N, and then shifting the empty location from gap N into page N.)
Insert the new table entry into the newly added (empty) location at the bottom of page N.
   In this way, the new table entry can be inserted into T-CAM 202, but at a cost of moving one existing table entry.

In general, if a configuration of the first category exists, then a new entry can be inserted into its associated page by (1) shifting an empty, immediately adjacent memory location into the associated page and (2) inserting the new entry into that location. In this case, the new entry can be inserted into the T-CAM without moving any existing entries.

If a configuration of the second category exists, then a new entry can be inserted into its associated page by (1) searching for the first page or gap having an empty memory location in the chosen direction (and, if none is found, then further searching for the first page or gap having an empty memory location in the other direction), (2) moving one or more existing table entries, if necessary, to create a temporary configuration of the first category in which the location immediately adjacent to the associated page in the search direction is now empty), (3) shifting that empty, immediately adjacent memory location into the associated page, and (4) inserting the new entry into that location.

Referring again to FIG. 3, since it is almost always preferable to insert a new entry without having to move any existing entries, after determining in step 304 that the associated page is full, memory manager 204 first checks to see whether the current configuration belongs to the first category. In particular, memory manager 204 determines whether the immediately adjacent gap in the chosen direction is empty (step 308). If it is empty, then memory manager 204 determines whether the immediately adjacent gap in the other direction is empty (step 310). If either of these gaps is not empty, then memory manager 204 shifts the immediately adjacent empty location into the associated page (step 320) and inserts the new table entry into that location (step 322). In this case, step 324 can be skipped, since no free-lists will be affected.

If both immediately adjacent gaps are empty (steps 308 and 310), then the current configuration belongs to the second category. In that case, starting from the corresponding side of the associated page, memory manager 204 sequentially examines the gaps and the page free-lists in the chosen direction to identify the first gap or page having an empty location (if any). If there are no empty locations at all in the chosen direction (i.e., the rest of the T-CAM is completely full in the chosen direction) (step 312), then memory manager 204 sequentially examines the gaps and page free-lists in the other direction (i.e., the direction opposite the chosen direction) to identify the first gap or page having an empty location (if any). If there are no empty locations at all in the other direction (i.e., the rest of the T-CAM is also completely full in the other direction) (step 314), then the entire T-CAM is completely full and memory manager 204 will be unable to insert the new entry into memory (step 316), at least not until an existing table entry is deleted.

If, however, one of the searches of steps 312 and 314 successfully identifies a first gap or page having an empty memory location, then memory manager 204 ensures that the location immediately adjacent to the associated page in current direction is empty (step 318). Depending on the current configuration of the T-CAM, this may involve moving one or more existing table entries within one or more pages and reassigning empty locations between pages and gaps. On the other hand, step 318 might not require any existing table entries to be moved.

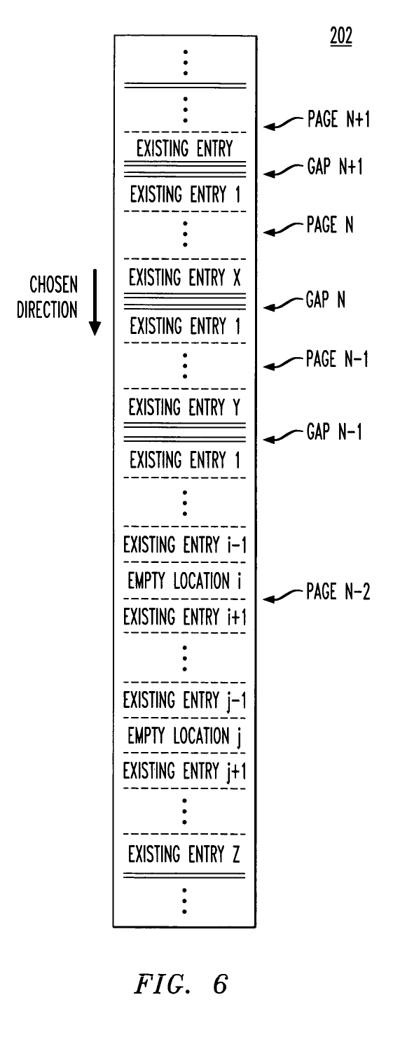

FIG. 6 shows a portion of T-CAM 202 of FIG. 2 that illustrates an example of a situation in which one or more existing entries need to be moved in order to ensure that the location immediately adjacent to the page associated with a new table entry is empty. In this example, page N is the page associated with the new table entry, gap N is the first gap in the chosen direction (i.e., down), page N−1 is the next page in the chosen direction, gap N−1 is the next gap in the chosen direction, and page N−2 is the subsequent page in the chosen direction. As indicated in FIG. 6:
Page N has X T-CAM memory locations associated with it, each of which already has an existing table entry;
Gap N has no (empty) T-CAM memory locations associated with it;
Page N−1 has Y T-CAM memory locations associated with it, each of which already has an existing table entry;
Gap N−1 has no (empty) T-CAM memory locations associated with it; and
Page N−2 has Z T-CAM memory locations associated with it, two of which (i.e., locations i and j) are empty, while each of the remaining Z−2 locations already has an existing table entry.
   Assume, further, in this example, that the free-list for page N−2 happens to identify location j ahead of location i.

In this case, the search of step 312 will identify page N−2 as the first page or gap in the chosen (i.e., down) direction having an empty location associated with it. Moreover, step 312 will select the first empty location in the free-list for page N−1 (i.e., location j) for use during the following operations, in which memory manager 204 ensures that the location immediately adjacent to page N in the down direction is empty:
Move the existing table entry at the top of page N−2 (i.e., location 1) to location j;
Shift the now empty location at the top of page N−2 into gap N−1;
Shift that empty location of gap N−1 into the bottom of page N−1;
Move the existing table entry at the top of page N−1 to the empty location now at the bottom of page N−1; and
Shift the now empty location at the top of page N−1 into gap N.

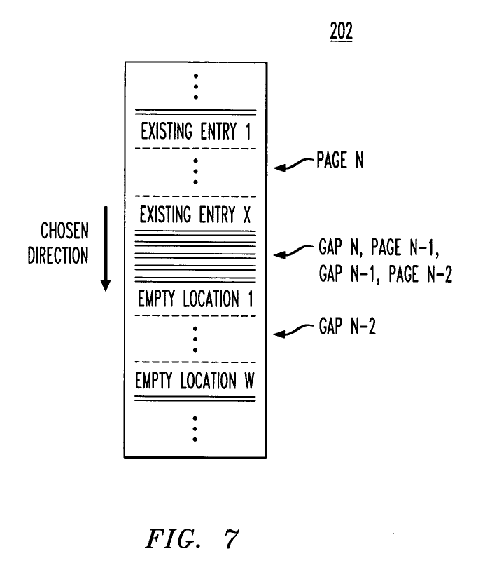

FIG. 7 shows a portion of T-CAM 202 of FIG. 2 that illustrates an example of a situation in which no existing entries need to be moved in order to ensure that the location immediately adjacent to the page associated with a new table entry is empty. In this example, page N is the page associated with the new table entry, gap N is the first gap in the chosen direction (i.e., down), page N−1 is the next page in the chosen direction, gap N−1 is the next gap in the chosen direction, page N−2 is the subsequent page in the chosen direction, and gap N−2 is the subsequent gap in the chosen direction. As indicated in FIG. 7:
Page N has X T-CAM memory locations associated with it, each of which already has an existing table entry;
Each of gap N, page N−1, gap N−1, and page N−2 has no T-CAM memory locations associated with it; and
Gap N−2 has W (empty) T-CAM memory locations associated with it.

In this case, the search of step 312 will identify gap N−2 as the first page or gap in the chosen (i.e., down) direction having an empty location associated with it. Memory manager 204 can ensure that the location immediately adjacent to page N in the down direction is empty by performing the following operations:
Shift the empty location at the top of gap N−2 into page N−2;
Shift that empty location of page N−2 into gap N−1;
Shift that empty location of gap N−1 into page N−1; and
Shift that empty location of page N−1 into gap N.

In any case, memory manager 204 then proceeds to shift the immediately adjacent empty location into the associated page (step 320), insert the new entry into that location (step 322), and, if necessary, update the appropriate free-list (step 324). Step 324 will be necessary when the empty location selected by step 312 or 314 was part of a page (rather than being part of a gap). If the selected empty location was part of a page, then that location (into which an existing entry was previously moved) is removed from that page's free-list. In the example of FIG. 6, previously empty, now occupied location j will be removed from the free-list of page N−2 during step 324.

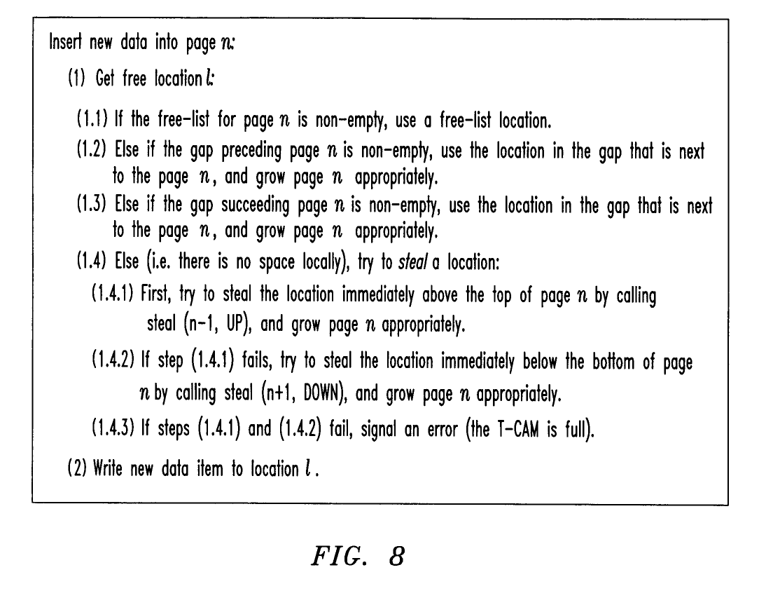

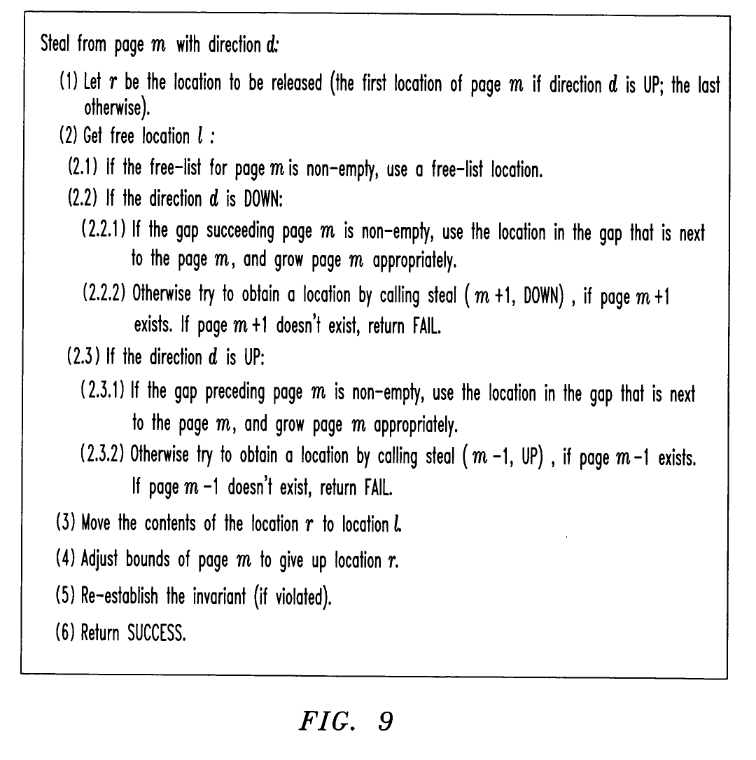

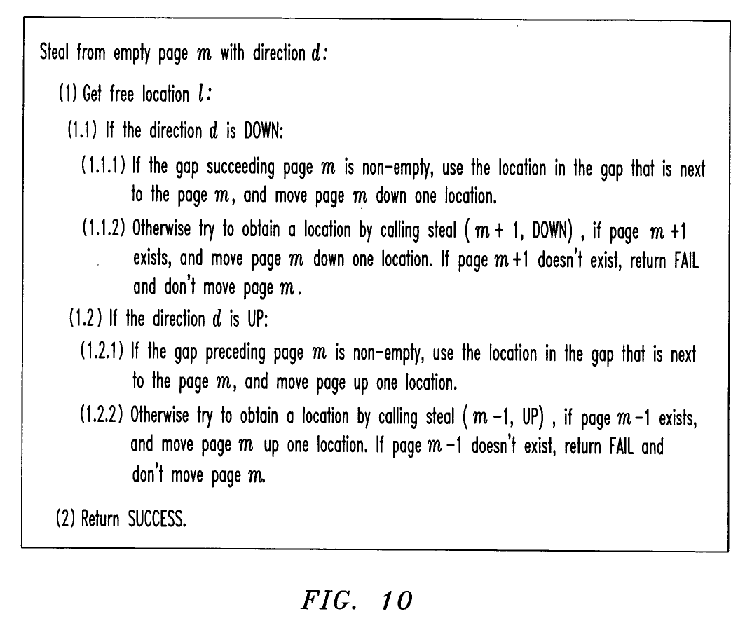

FIGS. 8-10 show pseudocode for inserting a new table entry into a T-CAM, according to one embodiment of the present invention. In particular, FIG. 8 shows the basic insertion algorithm (referred to as the function insert( )), FIG. 9 shows the algorithm for “stealing” a location from a page having one or more existing table entries, and FIG. 10 shows the algorithm for “stealing” a location from an empty page.

Referring to FIG. 8, steps (1.1)-(1.3) attempt to find an empty location “locally” (e.g., within the associated page or one of its two adjacent gaps). Step (1.4) is global; it directly affects one or more pages other than page n (i.e., the page associated with the new table entry).

The action of stealing a location from a neighboring page is performed by the function steal( ), defined in FIG. 9. This function is invoked with a page number m and a direction (either “up” or “down”). When called with direction “down,” the purpose of steal( ) is to release (i.e., free up) the first location of page m. When called with direction “up,” the purpose of steal( ) is to release the last location of page m. In the case where steal( ) is applied to an empty page, the algorithm is modified slightly as indicated in FIG. 10.

During the function steal( ), the invariant may be violated temporarily. For example, suppose that the direction is “down” and the second location of page m is on the associated free-list. After executing step (4) of steal( ), the new first location of page m will be on the free-list for page m. The purpose of step (5) is to re-establish the invariant by moving locations from the free-list to the adjacent gap (in this case, the gap immediately above page m).

The insert( ) and steal( ) algorithms look for free locations using a specific priority: find space locally before looking globally, and use the free-list of the associated page before using an adjacent gap. Looking locally first reduces the number of entries that need to be moved to accommodate the current insertion. Looking at the free-list first keeps the sizes of gaps at a maximum and therefore reduces the number of future moves. To illustrate this last point, suppose that a location is chosen from the gap just above page n instead of a location from the free-list. Further, suppose that this was the last location in this gap and that the next insertion is to page n−1. If page n−1 is full and the gap immediately above page n−1 is empty, then the next insertion cannot be performed locally, and a move will be required. This happens despite the fact that page n still has a non-empty free-list. In other words, locations in gaps offer maximum flexibility for future insertions and should be preserved when possible. Hence, the preferred algorithm uses free-list locations first, before using empty locations in adjacent gaps.

In the embodiments described above, the memory manager looks (locally) for a free space in only the associated page and its immediately adjacent gaps for an empty location, before looking globally in the chosen direction. This approach could overlook situations where no existing data entries need to be moved, such as the one in FIG. 7, where the location immediately adjacent to the associated page is empty, but it belongs to a gap that is not immediately adjacent to the associated page (i.e., there is at least one intervening, empty page). In alternative embodiments, the concept of looking locally could be extended to examine each location (and not just each gap) on both immediate sides of the associated page before starting to look globally for an empty location.

Deleting Existing Table Entries

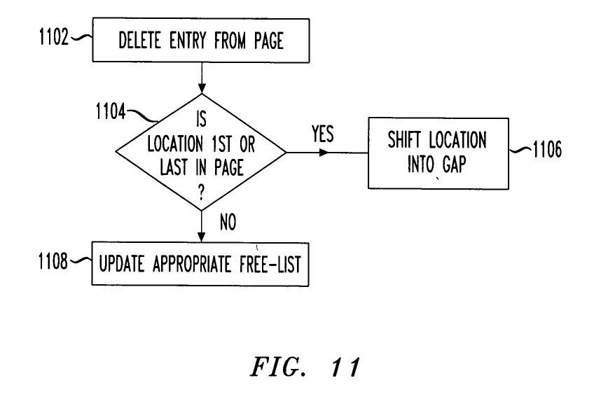

FIG. 11 shows a flow diagram of the processing implemented by memory manager 204 when an existing table entry needs to be deleted from T-CAM 202, according to one embodiment of the present invention. Memory manager 204 begins by deleting the entry from the associated page in T-CAM 202 (step 1102 of FIG. 11).

In light of the invariant, if the newly freed location is the first or last location in the associated page (step 1104), then that location is shifted from the associated page into the gap adjacent to that location (step 1106). This will increment by one the number of locations associated with that gap and decrement by one the number of locations associated with that page.

If, on the other hand, the newly freed location is interior to the associated page, then memory manager 204 adds the newly free location to the free-list associated with that page (step 1108).

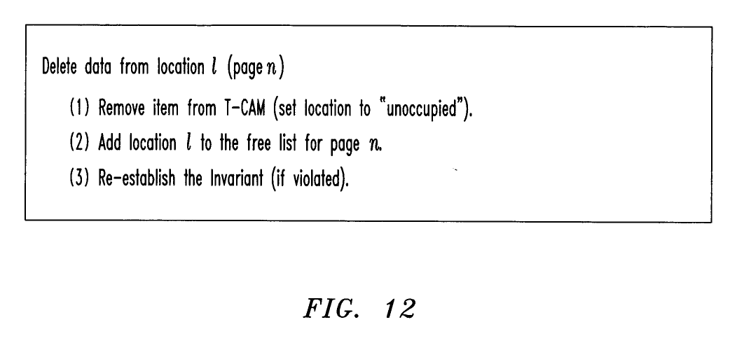

FIG. 12 shows pseudocode for deleting an existing table entry from a T-CAM, according to one embodiment of the present invention. In this embodiment, deleted locations are recorded in the appropriate free-list, and, if the invariant is violated by this step, elements are moved from the free-list to the appropriate gap, as necessary.

Pressure

The basic insert( ) algorithm of FIG. 8 incorporates a fixed strategy: look for free space above the current page before looking for free space below the current page (e.g., step (1.2) appears before step (1.3), and step (1.4.1) appears before step (1.4.2)). As the algorithm progresses, this bias of “up” before “down” means that the “upper” portions of the T-CAM will tend to get filled and the lower portions will tend to be under-utilized.

One approach for avoiding this imbalance is randomness: e.g., choose to do step (1.2) or step (1.3) first based on a random event, and similarly for steps (1.4.1) and (1.4.2).

A more powerful approach is to refine the insertion algorithm by equipping it with global information about table occupancy. Specifically, the occupancy of a region of a T-CAM is defined as the ratio of the number of occupied locations to the total number of locations within the region, where occupancy is a number between 0 and 1 inclusive. In the particular case where the region is empty, the occupancy is defined to be 1. Associated with each T-CAM page is a “pressure,” a real number parameter defined as follows: the pressure at page n equals (occupancy of region above page n)—(occupancy of region below page n), where “region above” refers to all of the memory locations above page n and “region below” refers to all of the memory locations below page n. Note that (i) the calculation of pressure for page n ignores the occupancy of page n, and (ii) pressures are between −1 and +1 inclusive.

Using pressure, the basic insertion algorithm of FIG. 8 is modified as follows. Whenever there is a choice of looking “up” or “down,” the direction “up” is chosen if pressure is negative and the direction “down” is chosen if pressure is positive. If the pressure happens to be zero, the direction can be chosen either randomly or arbitrarily.

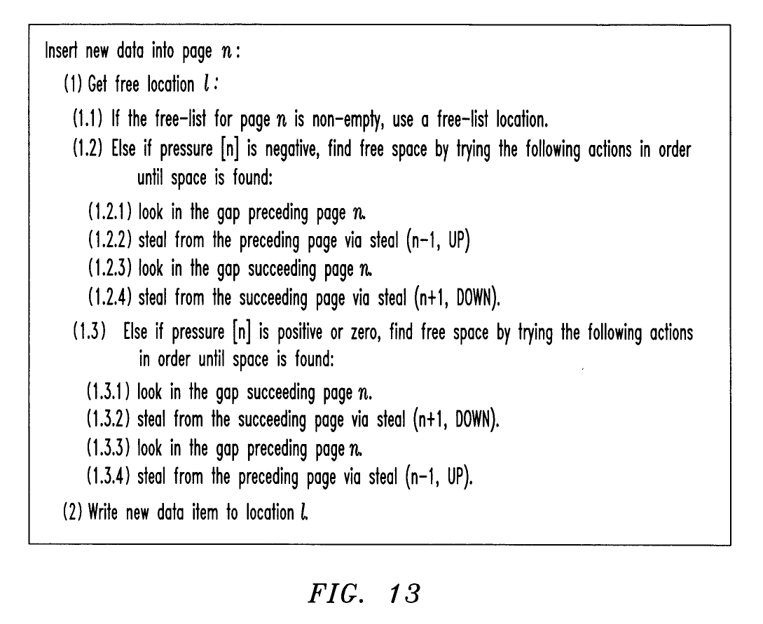

FIG. 13 shows pseudocode for the pressure-based insertion algorithm, according to one embodiment of the present invention.

The pressure at each page changes as entries are added and deleted from the T-CAM. As such, pressures will typically need to be re-computed over time. At one extreme, pressures could be recomputed after every insertion or deletion. This gives maximum accuracy, but adds a non-trivial cost to insertions/deletions. In practice, pressures change slowly and so recomputation every several hundred or thousand insertions/deletions will typically be satisfactory.

Intuitively, pressure adds a global component to the processing, since decisions about where to look for an empty location are now made with information about the state of the entire table. This not only helps make better informed decisions about how to service the current insertion, but it also reduces crowding for future insertions.

In conjunction with the invariant, pressure adds a dynamic capability to the algorithm that improves the efficiency of adapting the structure of pages as the profile of the entries in the T-CAM (e.g., the number of entries of each prefix length) changes.

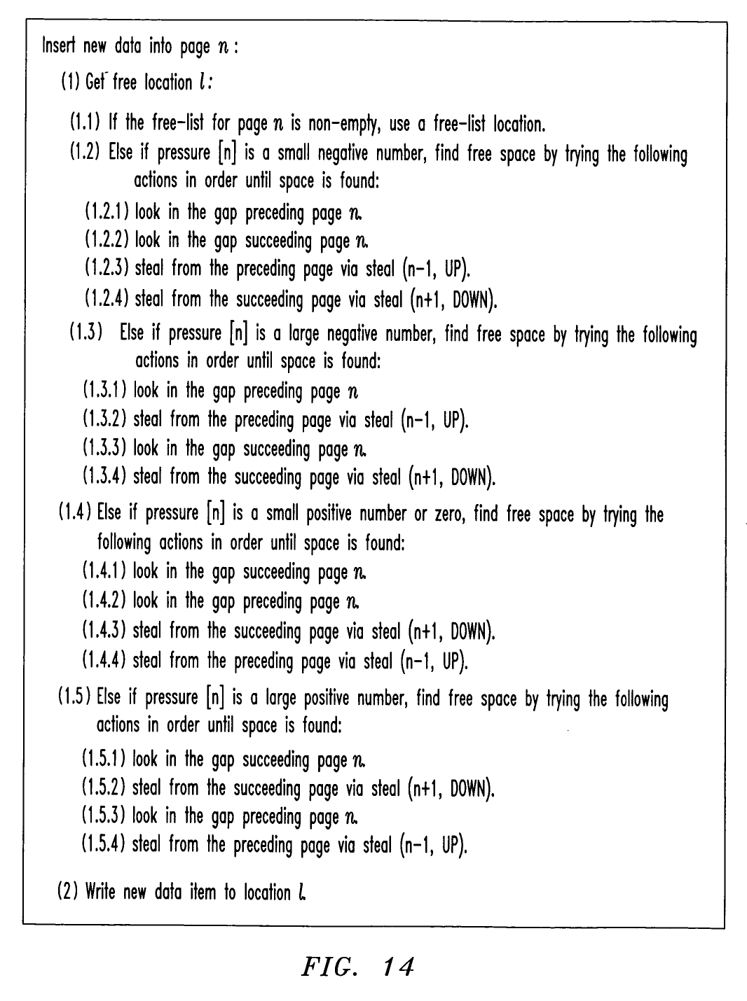

In the case where the magnitude of pressure is small, the T-CAM has relatively balanced occupancy, and so the direction chosen to look for free space is not significant. Hence, the pressure algorithm can be modified to give priority to insertion that does not involve entry moves. This is achieved by looking for space in gaps on both sides of the page before stealing, as detailed in FIG. 14, which shows pseudocode for an insertion algorithm that distinguishes between low pressure and high pressure situations. Empirically, treating pressures with magnitude 0.05 or less as “small pressures” gives useful performance benefits.

These pressure-based insertion algorithms are examples of amortized processes that potentially sacrifice short-term cost for long-term gain. The short-term cost can be minimized by searching in both directions and always selecting the closest empty location, since this will minimize the number of entries to be moved. Ironically, this scheme may result in a larger-than-optimal, long-term average number of entries moved. Instead, by choosing the search direction based on the global table characteristic of pressure, amortized algorithms in accordance with the present invention may end up moving more entries than absolutely necessary for any given insertion in order to achieve a smaller overall average number of moved entries for all insertions.

Although not strictly required, before inserting the very first table entry, a T-CAM's memory map can be partitioned into pages and gaps based on an expected distribution of numbers of entries with different prefix lengths based empirically on typical IP routing tables. For implementation in which the invariant applies, such an initial partition would identify locations of empty pages (i.e., pages having no locations assigned to them) with all of the (empty) memory locations assigned to the intervening gaps.

Although the present invention has been described in the context of a memory manager that maintains gaps on either side of each page, the invention is not so limited. In one alternative embodiment, the gaps at the beginning and end of the T-CAM (e.g., gaps 0 and 33 in FIG. 2) are eliminated with their corresponding locations associated with the first and last pages (e.g., pages 0 and 32 in FIG. 2), respectively. This embodiment is based on the recognition that gaps 0 and 33 of FIG. 2 are not shared by two different pages. In this case, the invariant would not apply to the bottom of page 0 or to the top of page 32. In another alternative embodiment, the memory manager does not maintain any gaps at all. In this case, each T-CAM location is associated with a page, and the invariant would not apply at all.

Although the present invention has been described in the context of managing an IPv4 table having 32-bit entries, the present invention is not so limited. For example, the present invention could be implemented to manage an IP version 6 (IPv6) table having 128-bit entries. In general, the present invention can be used to manage storage of data entries for any suitable matching problem in which the entries are organized in pages of entries sharing some common attribute (i.e., where prefix length is just one possible attribute), where the order of the pages is important, but not necessarily the order of entries within each page.

Although the present invention has been described in the context of memory management for T-CAMs, the present invention can also be implemented for other suitable memory devices or configurations.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

1. A method for managing storage of entries in a memory, comprising:
organizing the memory into pages, each page having zero, one, or more memory locations adapted to store entries sharing a common attribute;
maintaining a free-list for each page, wherein each free-list identifies any empty memory locations currently in the corresponding page; and
managing storage of the entries in the memory based on the free-lists.

2. The invention of claim 1, wherein the memory is a ternary content-addressable memory (T-CAM).

3. The invention of claim 1, wherein the entries correspond to IP routing addresses and the common attribute is address prefix length.

4. The invention of claim 1, wherein the pages in the memory are organized based on the common attribute.

5. The invention of claim 4, wherein the common attribute is entry prefix length, and the pages are organized in order of descending entry prefix length.

6. The invention of claim 4, wherein order of entries within each page is not constrained.

7. The invention of claim 1, further comprising maintaining a gap of zero, one, or more empty memory locations between each adjacent pair of pages in the memory, wherein the storage of the entries in the memory is managed based on the gaps.

8. The invention of claim 7, wherein:
an empty location at the top of any page having a gap immediately above it, is shifted into that gap; and
an empty location at the bottom of any page having a gap immediately below it, is shifted into that gap.

9. The invention of claim 7, wherein, when an entry is deleted from a location at the beginning or the end of a page, the location is shifted into a gap adjacent to the page.

10. The invention of claim 1, further comprising, when a page has no empty locations for inserting a new entry, choosing, based on an amortized search scheme, a direction to search for an empty location, wherein the amortized search scheme does not necessarily identify the closest empty location for inserting the new entry.

11. The invention of claim 10, wherein the amortized search scheme is based on a measure of relative fullness of regions in the memory above and below the page.

12. The invention of claim 1, wherein a new entry is inserted into the memory at a location identified in the free-list of the corresponding page.

13. The invention of claim 12, wherein, if the free-list of the corresponding page is empty, then a search is performed for an empty location outside of the corresponding page.

14. The invention of claim 13, wherein the direction of the search is chosen based on a measure of relative fullness of regions in the memory above and below the corresponding page.

15. The invention of claim 13, wherein the search looks for an empty location in a gap immediately adjacent to the corresponding page before looking for another gap or page having an empty location.

16. The invention of claim 15, wherein, when there are one or more intervening existing entries between the corresponding page and an empty location, one or more of the intervening existing entries are moved to free up a location immediately adjacent to the corresponding page.

17. The invention of claim 16, wherein the freed-up location is shifted into the corresponding page and the new entry is inserted into the freed-up location.

18. A machine-readable medium, having encoded thereon program code, wherein, when the program code is executed by a machine, the machine implements a method for managing storage of entries in a memory, the method comprising:
organizing the memory into pages, each page having zero, one, or more memory locations adapted to store entries sharing a common attribute;
maintaining a free-list for each page, wherein each free-list identifies any empty memory locations currently in the corresponding page; and
managing storage of the entries in the memory based on the free-lists.

19. A memory system comprising a memory and a memory manager adapted to manage storage of table entries in the memory, wherein the memory manager is adapted to:
organize the memory into pages, each page having zero, one, or more memory locations adapted to store entries sharing a common attribute;
maintain a free-list for each page, wherein each free-list identifies any empty memory locations currently in the corresponding page; and
manage storage of the entries in the memory based on the free-lists.

20. A memory system comprising a memory and a memory manager adapted to manage storage of table entries in the memory, wherein the memory manager comprises:
circuitry adapted to organize the memory into pages, each page having zero, one, or more memory locations adapted to store entries sharing a common attribute;
circuitry adapted to maintain a free-list for each page, wherein each free-list identifies any empty memory locations currently in the corresponding page; and
circuitry adapted to manage storage of the entries in the memory based on the free-lists.

21. The invention of claim 20, wherein the memory manager is implemented in an integrated circuit.
